(19) United States
(12) Patent Application Publication
(10) Pub. No.: US 2008/0111266 A1
(43) Pub. Date: May 15, 2008

(54) Manufacturing Method of a Cross-Linked Foam

(76) Inventor: Jang-Won Park, Busan (KR)

Correspondence Address: BIRCH STEWART KOLASCH & BIRCH, PO BOX 747, FALLS CHURCH, VA, 22040-0747, US

(21) Appl. No.: 11/791,001

(22) PCT Filed: Apr. 13, 2005
(86) PCT No.: PCT/KR05/01076

§ 371 Date: May 17, 2007

(30) Foreign Application Priority Data
Dec. 3, 2004 (KR) 10-2004-0101130

(51) Int. Cl. B29C 44/06

(52) U.S. Cl. 264/45.6

(57) ABSTRACT

The present invention provides a manufacturing method of a cross-linked foam, comprises processing foaming material for a foam body to have a certain shape with a cross-linked foaming suppressed and processing at least one foaming material for an outer skin to have a shape of a thin film with a cross-linked foaming suppressed, the foaming material for the outer skin including a pigment; disposing the foaming material for the outer skin and the foaming material for the foam body in a molding die, the foaming material for the outer skin disposed in an inner cavity of the molding die and then the foaming material for the foam body disposed on the foaming material for the outer skin for the foaming material for the outer skin to cover a surface of the foaming material for the foam body; and cross-linked foaming the disposed foaming material for the foam body and the outer skin, whereby an united foam covered with the outer skin having a wide variety of colors can be manufactured even without an additional attachment or a painting process.

### TECHNICAL FIELD

The present invention relates to a manufacturing method of a cross-linked foam, and more specifically a manufacturing method of a cross-linked foam by which a united foam covered with an outer skin having a wide variety of colors can easily be obtained without an additional attachment or painting process.

### BACKGROUND ART

Recently, a foamed product obtained by a cross-linked foaming of diverse resins such as polyethylene (PE) or ethylene-vinyl acetate (EVA) is actively used in a wide range of industries. The use of the cross-linked foam has been increased owing to its properties such as a low specific gravity, superior elasticity and shock absorption. Besides, it is easy to form a desired shape of the cross-linked foam only by using a molding die having a desired shape.

Because customers are inclined to pay a special attention to an appearance of the foamed products specially when there is little difference in a quality of the foamed products manufactured by different producers, the producers has been trying to improve the appearance of the foamed products. One of the most common ways to make a visual effect on the foamed product is to make the foamed product to have a single color by mixing pigment corresponding to the desired color with foaming material compound. However, the foamed product according to the above-mentioned method shows only a same and single color so that it is impossible to differentiate the color effect of the foamed product depending on portions of the foamed product.

The customers usually have a preference for a foamed product including gloss pigment giving a luxurious appearance or functional pigment such as UV pigment. Because such pigments is very expensive, the manufacturing cost is increased when the foamed product is produced by the above-mentioned method.

To overcome the above-mentioned problems, each component of the foamed products having different color is individually formed and then the formed components are attached together using additional adhesives. According to this method, it is possible to decrease the manufacturing cost by adding expensive pigments only to portions of the foamed product to which the customers usually pay attention. However, each portions having different colors must be individually formed and then assembled together according to this method, the numbers of a molding die is increased so that the manufacturing cost of the assembled foamed product is increased. Furthermore, as the number of colors of the foamed products is increased, the manufacturing yield will be lowered owing to repeated individual processes.

Moreover, the number of colors that can be embodied to the foamed product is limited and a sense of unity of the final product is poor according to the related art because individual components are put together to complete the final foamed product having different colors. The durability of the foamed product is low because the assembled part of the foamed product is easily taken from other assembled parts of the foamed product. In an alternative way to give a desired color effect to the foamed product, a specific portion of the foamed product is painted with special ink or paint using a paintbrush or a spray gun. For example, the process to make the foamed components of a shoe such as soles to have a desired color comprises following steps. In a first step, a portion of the sole that is to be painted is washed away and dried as a preliminary process before a painting. In a second step, a mask is formed along a boundary differentiated by colors. At this step, if the whole surface of the sole is to be painted, the masking may be unnecessary. A portion that is not covered with the mask is painted with ink or paint having a low viscosity and a high fluidity and then dried. A primer treatment process may further be added to the above steps before the painting step to improve an attachment between the painting material and a surface of the sole. As described above, the necessary steps for giving a desired color to the desired portion of the foamed products is too complex. Accordingly, the productivity of the foamed product having diverse colors depending on portions becomes very poor considering that many soles of the shoe having diverse curves and a three-dimensional shapes are widely produced in the field. Moreover, if only a special portion of the sole is to be painted, the productivity will be lowered more.

In addition, the additional process to wash the portion of the foamed product before the painting process to remove impurities on the surface and increase an adhesive strength between the surface and the painting material will lower the productivity also. When the primer treatment process is added to the painting process, the productivity will be decreased much more. Because whether the mask is perfectly formed on the surface of the foamed product along an outline of the foamed product or not can be checked only when the mask is separated from the foamed product after a completion of the painting process, an inferiority may be occurred to the foamed product owing to a poor sealing of the mask to the surface of the foamed product.

One of the ways to decrease the possibility of generation of the inferiority in the foamed product is to adhere a masking tape having a shape of a thin film to the surface of the foamed product. The masking tape must be cut considering the outline of the outer surface of the foamed product. However, because this method requires a high degree of difficulty and skill the productivity is further lowered. In addition, an inexact location of the masking tape or a separation of the masking tape may further increase a percentage of an inferior product.

Furthermore, even if the coloring of the surface of the foamed product is completed by the above method, the painted film may be deteriorated and contaminated by a careless treatment or a contact with other material. This phenomenon may become more serious when the whole surface of the foamed product such as the sole of the shoe is painted in a same color.

### DISCLOSURE

### TECHNICAL PROBLEM

Accordingly, the present invention has been made keeping in mind the above problems occurring in the related art, and an object of the present invention is to provide a manufacturing method of a cross-linked foam by which diverse color of an outer skin can be obtained simply and efficiently.

### TECHNICAL SOLUTION

To achieve these and other advantages and in accordance with the purpose of the present invention, as embodied and broadly described, a manufacturing method of a cross-linked foam, comprises processing foaming material for a foam body to have a certain shape with a cross-linked foaming suppressed and processing at least one foaming material for an outer skin to have a shape of a thin film with a cross-linked foaming suppressed, the foaming material for the outer skin including a pigment; disposing the foaming material for the outer skin and the foaming material for the foam body in a molding die, the foaming material for the outer skin disposed in an inner cavity of the molding die and then the foaming material for the foam body disposed on the foaming material for the outer skin for the foaming material for the outer skin to cover a surface of the foaming material for the foam body; and cross-linked foaming the disposed foaming material for the foam body and the outer skin, whereby a united foam covered with the outer skin having a wide variety of colors can be manufactured even without an additional attachment or a painting process.

In another aspect of the present invention, the present invention provide a manufacturing method of a cross-linked foam that comprises firstly processing foaming material for a foam body to have a certain shape with a cross-linked foaming suppressed and processing at least one foaming material for an outer skin to have a shape of a thin film with a cross-linked foaming suppressed, the foaming material for the outer skin including a pigment; secondly processing the firstly processed foaming materials to obtain an united foaming material by covering a surface of the foaming material for the foam body with the foaming material for the outer skin; disposing the united foaming material in a molding die; and cross-linked foaming the disposed foaming material, whereby a united foam covered with the outer skin having a wide variety of colors can be manufactured even without an additional attachment or a painting process.

In the above, the foaming material for the foam body may include a pigment that is same as or different from the pigment included in the foaming material for the outer skin.

In the above, the foaming material for the outer skin may cover the whole surface of the foaming material for the foam body when the foaming materials are disposed in the molding die.

In the above, the foaming material for the outer skin may cover a portion of the surface of the foaming material for the foam body when the foaming materials are disposed in the molding die.

In the above, the foaming material for the outer skin may consist of plural foaming materials and at least one of the plural foaming materials covers the whole surface of the foaming material for the foam body.

In the above, the foaming material for the outer skin may consist of plural foaming materials and at least one of the plural foaming materials covers a portion of the surface of the foaming material for the foam body.

In the above, the whole surface of the firstly processed foaming material for the foam body may be tightly covered with the firstly processed foaming material for the outer skin during the second process of the foaming materials.

In the above, a portion of the surface of the firstly processed foaming material for the foam body may be tightly covered with the firstly processed foaming material for the outer skin during the second process of the foaming materials.

In the above, the foaming material for the outer skin may consist of plural foaming materials and at least one of the plural foaming materials may cover the whole surface of the foaming material for the foam body.

In the above, the foaming material for the outer skin may consist of plural foaming materials and at least one of the plural foaming materials may cover a same portion of the surface of the foaming material for the foam body.

In the above, the foaming material for the outer skin may further have at least one open portion.

In the above, the method may further comprises removing a portion of the outer skin to expose a portion of the foam body or a portion of another outer skin after the cross-linked foaming process.

In the above, the method may further comprise re-molding the foam after the removing process for a surface treatment of the exposed portion.

In the above, each of the plural foaming materials for the outer skin may include either of same or different pigment.

In the above, only the outermost foaming material among the plural foaming materials for the outer skin may include the pigment.

In the above, foaming material having a shape of a sheet or a pellet with the cross-linked foaming suppressed is used for the foaming material for the foam body.

In the above, the foaming material for the foam body may be formed by processing foaming material having a shape of a sheet or a pellet with the cross-linked foaming suppressed.

In the above, the foaming material for the foam body may be formed by laminating plural foaming materials having a shape of a thin film with the cross-linked foaming suppressed.

In the above, each of the plural foaming materials for the foam body may be a film having a uniform and even surface.

In the above, each of the plural foaming materials having a shape of a thin film may be formed by processing a sheet or a pellet type foaming material with the cross-linked foaming suppressed.

In the above, the foaming material for the outer skin having a shape of a thin film may be formed by processing a sheet or a pellet type foaming material with the cross-linked foaming suppressed.

In the above, the foaming material for the outer skin may be a film having a uniform and even surface.

It is to be understood that both the foregoing general description and the following detailed description are exemplary and explanatory and are intended to provide further explanation of the invention as claimed.

### ADVANTAGEOUS EFFECTS

According to the present invention, a higher productivity can be attained as compared with the related art by foaming the foaming material for a foam body and the foaming material for the outer skin having a diverse color at a time without an additional attachment or a painting process. Besides the foamed product according to the present invention can satisfy the customer diverse taste by realizing a differentiation of colors depending portions of the foamed product by a simple process.

The foamed product according to the present invention can be differentiated from other foamed products manufactured by the related art in that the foamed product of the present invention has a superior appearance to that of the related art by adding desired pigment only to the thin outer skin of the foam, thereby cutting down the manufacturing cost.

In addition, the coloring of the foam is fulfilled by uniformly mixing pigment with the foaming material and then cross-linked foaming the mixed foaming material so that the deterioration of the painted layer or the separation of the attached component can be prevented.

The present invention is also environment-friendly compared with the related art in that many harmful chemicals such as a solvent used is unnecessary.

### BRIEF DESCRIPTION OF DRAWINGS

The above and other objects, features and other advantages of the present invention will be more clearly understood from the following detailed description taken in conjunction with the accompanying drawings, in which:

FIG. 1 is a plan view of a cross-linked foam according to an embodiment of the present invention;

FIG. 2 is a cross-sectional view of the cross-linked foam taken along a line A-A′ of FIG. 1;

FIG. 3 is a cross-sectional view of a cross-linked foam according to another embodiment of the present invention;

FIG. 4 is a plan view of a cross-linked foam according to another embodiment of the present invention;

FIG. 5 is a cross-sectional view of the cross-linked foam taken along a line B-B′ of FIG. 4;

FIG. 6 is a plan view of a cross-linked foam according to another embodiment of the present invention;

FIG. 7 is a cross-sectional view of the cross-linked foam taken along a line C-C′ of FIG. 6;

FIG. 8 is a cross-sectional view of a cross-linked foam of the present invention illustrating an additional process;

FIG. 9 is a cross-sectional view of the cross-linked foam of the present invention after the additional process of FIG. 8;

FIG. 10 is a side view of a shoe component according to an embodiment of the present invention;

FIG. 11 is a cross-sectional view of the shoe component taken along a line D-D′ of FIG. 10;

FIG. 12 is a partial cross-sectional view of a shoe component embodied according to another embodiment of the present invention;

FIG. 13 is a partial cross-sectional view of the shoe component obtained by an additional process of FIG. 12;

FIG. 14 is a side view of a shoe component according to another embodiment of the present invention; and

FIG. 15 is a cross-sectional view of the shoe component taken along a line E-E′ of FIG. 14.

### MODE FOR THE INVENTION

Reference will now be made in detail to the preferred embodiment of the present invention, which is illustrated in the accompanying drawings.

The present invention mainly comprises a step of processing foaming material, a step of disposing the processed foaming material in a molding die and a step of cross-linked foaming the disposed foaming material. The present invention may further include steps of exposing a certain portion of a foam and re-molding the foam.

In the step of processing the foaming material, foaming material for a foam body that becomes a body of the final foam and foaming material for an outer skin that covers a surface of the final foam are formed to have a certain shape with a cross-linked foaming suppressed. At this time, the foaming material for the outer skin includes pigment and has a shape of a thin film. In a step of disposing the processed foaming materials, the processed foaming materials are properly put into a cavity of the molding die. Though the processing and disposing of the foaming material may be fulfilled in many ways, it is desirable to select one of following methods.

As one of the desirable ways of processing and disposing the foaming material, the foaming material for the foam body and the foaming material for the outer skin having a shape of the thin film and including the pigment are individually processed to form a certain shape and the individual foaming material is disposed into the molding die individually. The processing of the foaming material may be fulfilled as follows. Because the shape of the foaming material for the foam body can be changed depending on a diverse shape of the cavity of a molding die, the shape of the foaming material for the foam body is not limited only if the necessary weight of the foaming material for the final foam is accurately measured. However, because the foaming material with the cross-linked foaming suppressed has certain hardness, it is desirable to form the foaming material into a shape that can be easily disposed into the molding die. Any method selected from the group consisting of an injection type, a compression type, a vacuum forming type and a combination or a modification of those types can be adopted for processing the foaming material for the foam body only if the foaming material for the foam body can be processed with the cross-linked foaming suppressed. Unlike the above-mentioned way in which the foaming material having the certain shape is acquired by a single process, the foaming material for the foam body having a certain shape can be obtained by processing the foaming material into a shape of a thin film, laminating plural foaming materials having the shape of the thin film in the cavity of the molding die having a shape of the desired foam body and re-processing the laminated foaming materials. AT this time, the foaming material is obtained with the cross-linked foaming suppressed. In an alternative way, the foaming material for the foam body having the certain shape can be obtained by processing the foaming material into a shape of a thin film, cutting the thin film type foaming materials into a certain shape corresponding to the shape of the foam body, laminating the cut foaming materials and re-processing the laminated foaming materials with the cross-linked foaming suppressed.

Moreover, foaming materials in a shape of a sheet or a pellet with the cross-linked foaming suppressed may be selected for the foaming material for the foam body. A foaming material having a certain shape with the cross-linked foaming suppressed that is formed by processing the foaming materials having the shape of a sheet or a pellet may be used for the foaming material for the foam body. As an alternative, the foaming material may be formed into a shape of a thin film with the cross-linked foaming suppressed to be used for the foaming material for the foam body.

When the foaming material for the foam body consists of plural layers of foaming materials, the individual layer of the foaming material may desirably have a same shape as that of foaming material for the outer skin and be processed in a same way as that of the foaming material for the outer skin that will be explained later.

The foaming material for the outer skin including the pigment may desirably be formed in a shape of a thin film considering the fact that it covers the foaming material for the foam body that is a body of the final foam. Specifically, the foaming material for the outer skin may be formed in a film type having an even surface and a uniform degree of surface roughness with the cross-linked foaming suppressed for the reason as follows. When the foaming materials with the cross-linked foaming suppressed are cross-linked foamed in the molding die, there occurs permeation across a boundary between the foaming materials and the permeation happens more stably when a thickness of each portion of the foaming material is uniform. Accordingly, if the foaming material for the outer skin is formed in a shape of the film, it becomes easy to form a uniform interfacing surface specially when the foaming material for the outer skin includes pigment for a coloring. If the foaming material for the outer skin has a shape that is difficult to correspond to a shape of the cavity of the molding die, the disposition of the foaming material having a certain degree of hardness into the cavity of the molding die may be impossible. For this reason, the foaming material for the outer skin may desirably be formed in the form of a thin film or a thin layer. Specially, because soles as components of the shoe that is obtained by the cross-linked foaming method has more complex appearance than before, the necessity for forming the foaming material in a shape of the thin film is increased.

When a functional pigment needs to be included in the foaming material, a pigment having a lower cost may be included in the foaming material for the foam body and an expensive functional pigment may be included only in the foaming material for the outer skin that is observed from the outside. Otherwise, the functional pigment can be included only in the foaming material for the outer skin because only the outer skin is observed from the outside.

Meanwhile a thickness of the foaming material for the outer skin may desirably be in a range between 0.1 mm and 2 mm. However, the thickness of the foaming material may be decided considering the permeation phenomenon between the foaming materials and additional processes that will be explained later.

Though a forming method of the foaming material for the outer skin is not confined to a certain processing method as long as a surface evenness and a small deviation of surface roughness is guaranteed, a calender forming method related with a roll milling method or a calender forming method related with a extrusion forming method may desirably selected as the forming method of the foaming material for the outer skin having a thin film shape. The foaming material for the outer skin may be provided by forming a properly mixed chemical compound into a thin film shape by the above-mentioned method or by re-processing the sheet or pellet type foaming material with the cross-linked foaming suppressed to have a form of a thin film.

Once the foaming materials for the foam body and the outer skin are prepared, the foaming materials are disposed in the cavity of the molding die. At least one foaming material for the outer skin is disposed on a bottom surface of the cavity of the molding die and then the foaming material for the foam body is disposed on the foaming material for the outer skin in a way that the foaming material for the outer skin covers a whole surface of the foaming material for the foam body or a portion of the surface of the foaming material for the foam body. If the foaming material for the outer skin covers the foaming material for the foam body entirely, the outer skin that is formed by a cross-linked foaming of the foaming material for the outer skin is observed from the outside. If the foaming material for the outer skin covers the foaming material for the foam body partially, a portion of the foam body corresponding to the portion of the foaming material for the foam body that is not covered with the foaming material for the outer skin is observed from the outside after the cross-linked foaming process.

The foaming material for the outer skin may have a layered structure formed by plural layers of the foaming material for the outer skin. When the foaming material for the outer skin consists of plural foaming materials, at least one of the plural foaming materials may cover the whole surface of the foaming material for the foam body. If the foaming material for the outer skin consists of plural foaming materials and at least one of the plural foaming materials covers a portion of the foaming material for the foam body, at least one of the plural foaming materials covers a same or different portion of the foaming material for the foam body.

If all of the plural foaming materials for the outer skin covers a same portion of the foaming material for the foam body and then goes through the cross-linked foaming process, an outermost skin is exposed to the outside. If each of the plural foaming materials for the outer skin covers a different portion of the foaming material for the foam body and then goes through the cross-linked foaming process, different layers are exposed to the outside according to the portion that it covers. Accordingly, in this case, each of the portions of the foam may have a different color when each of the plural foaming materials includes a different pigment for a different color. A thickness of each of the plural foaming materials having the thin film shape may be same or different. A shape of the cavity of the molding die can be diversely modified depending on the shape of the final foam.

If the foaming material is disposed in the molding die while the molding die is kept at a high temperature, the thin film type foaming material is melted down and flows causing a permeation phenomenon between the foaming materials. This abnormal permeation phenomenon increases the possibility of an inferior foam. Though this problem can be prevented by controlling the thickness of the foaming material for the outer skin, it is desirable that the molding die be kept at a low temperature during a disposition of the foaming material for the outer skin in the molding die.

In another embodiment of the present invention, the foaming material for the foam body and the foaming material for the outer skin can be formed in a united foaming material and then the united foaming material may be disposed in the molding die. For example, one of the foaming materials for the foam body and the outer skin may be formed into a certain shape with the cross-linked foaming suppressed and then disposed in the molding die. Subsequently, the united foaming material with the cross-linked foaming suppressed can be obtained by putting the mixed foaming material in a space between the disposed foaming material and the cavity of the molding die. However, it is desirable that the united foaming material be formed as follows.

In a first processing step, the foaming material for the foam body is formed in a certain shape using raw material such as a sheet or a pellet type foaming material with the cross-linked foaming suppressed and the foaming material for the outer skin including the pigment is formed in a thin film with cross-linked foaming suppressed. The raw materials and the forming method of the foaming materials for the foam body and the outer skin are same as in the previous embodiments.

In a second processing step, the foaming material for the outer skin having the shape of a thin film is processed to cover the foaming material for the foam body having the certain shape. If the foaming material for the outer skin consists of plural foaming materials for the outer skin, at least one of the plural foaming materials covers the foaming material for the foam body. In this step, the firstly processed foaming material for the outer skin having the thin film shape is disposed in the cavity of the molding die having a cavity shape corresponding to a desired foam body. At this time, the foaming material for the outer skin may contact the bottom surface of the cavity of the molding die. The firstly process foaming material for the foam body is subsequently disposed on the disposed foaming material for the outer skin and then a combination of the foaming materials for the foam body and the outer skin is formed in the united foaming material with the cross-linked foaming suppressed. If the shape of the united foaming material is same as or similar with the shape of the first processed foaming material for the foam body, the molding die used in the first processing step can be reused in the second processing step without an additional molding die. However, the united foaming material may be formed in a different shape from that of the firstly processed foaming material for the foam body. In this case, the shape of the firstly processed foaming material for the foam body is changed during the second processing step and the additional molding die for the second processing step is required.

The foaming material for the foam body may be formed by the sheet or pellet type foaming material as mentioned before. The number of the necessary molding die depends on whether the sheet or pellet type foaming material is directly used for the foaming material for the foam body or the foaming material for the foam body is formed in a certain shape by re-processing the sheet or pellet type foaming material.

The firstly processed foaming material for the foam body may have a layered structure. That is, a plurality of foaming materials having a shape of a thin film may be laminated to form the firstly processed foaming material for the foam body.

In the second processing step for forming the united foaming material, the foaming material for the outer skin may cover the whole surface or a portion of the surface of the foaming material for the foam body. If the foaming material for the outer skin consists of the plural foaming materials for the outer skin having the thin film shape, at least one of the foaming materials for the outer skin may cover the whole surface of the foaming material for the foam body or each of the foaming material for the outer skin may cover the same or different portions of the foaming material for the foam body. When the plural foaming materials for the outer skin is secondly processed, the foaming material for the foam body may also consist of the plural foaming materials for the foam body in a layered structure.

In this embodiment, because only the united foaming material is simply disposed in the cavity of the molding die, the disposition process is easy and simple. Because the united foaming material having a volume is directly disposed in the molding die unlike the previous embodiment in which the foaming material for the outer skin having the thin film shape is firstly disposed in the molding die and then the foaming material for the foam body is disposed thereon, the molding die can be kept at a relatively high temperature. As in the previous embodiment, the shape of the cavity of the molding die is not confined to a certain shape. Each of the foaming materials for the foam body and the outer skin is formed by using chemical compound including a main material and additives. The main material can be selected from many materials used in the filed for a cross-linked foaming. The foaming material may be obtained by mixing a foaming agent with the main material. The main material may be selected from the group consisting of ethylene-vinyl acetate (EVA) based resin having diverse vinyl acetate content (VA %), polyethylene (PE) based resin having diverse density, rubber material, and a material obtained by combining or polymerizing those materials. However any material that can be used for the cross-linked foaming can be selected for the present invention as long as the object of the present invention can be reached.

At least one open portion such as a hole may be formed in the foaming material for the outer skin. The shape of the open portion can be designed diversely considering a kind, a shape and a usage of the final foam. If the foaming material for the outer skin having the open portion goes through a cross-linked foaming process, a portion of the foaming material for the foam body flows out of the open portion so that the portion of the foaming material for the foam body can be seen from the outside. This gives the final foam a special and visual effect to improve the appearance. If the foaming material for the outer skin consists of the plural foaming materials and each of the plural foaming materials has the open portion in a different portion, the foaming material for the outer skin that is right next to the outermost foaming material for the outer skin flows out of the open portion of the outermost foaming material for the outer skin.

Though the pigment is not confined to a certain kind of pigment, it can be freely selected from the various kinds of pigments, i.e., a natural pigment, a synthetic pigment, an organic pigment, an inorganic pigment, a functional pigment such as a UV pigment, a gloss pigment, etc. If the foaming material for the outer skin consists of the plural foaming materials, each of the plural foaming materials includes a different pigment or includes a same pigment by turns to show diverse display of colors. An expensive pigment having a high quality may be included only in the outermost foaming material for the outer skin that can be seen from the outside, which reduces a manufacturing cost by decreasing an amount of the expensive pigment.

The foaming material for the foam body may include pigment that is same as or different from the pigment included in the foaming material for the outer skin. The foaming materials for the foam body and the outer skin may have the pigment for the same color but a high quality pigment such as the gloss pigment may only be included in the foaming material for the outer skin so that the whole foam seems to have a superior appearance. Finally, if the processed foaming material is disposed in the molding die and then cross-linked foaming process is performed by pressing and heating the molding die, a final foam having a different color between the foam body and the outer skin or between the outer skinks is obtained without an additional attachment or a painting process.

The present invention may further include a step of removing a certain portion of the foam to expose a portion of the foam body or the outer skin. A position, a shape and a depth of the portion that is removed can be designed freely. The removing process can be performed by a grinder, a knife, a cutter or a laser device and is not confined to those tools and devices. The foam obtained through the removing process may look alike the foam obtained by forming the open portion in the foaming material for the outer skin and then foaming it. If both of the two methods are applied to a manufacturing of the foam, the final foam produced will have a much more diverse appearance.

Because the exposed portion of the foam may have a rough surface depending on the tools or device for the removing process, the foam may goes through a re-molding process for a treatment of the exposed surface.

Generally the final foam may be obtained by cutting and grinding a first cross-linked foam that is formed by a compression foaming method or an injection foaming method and then re-forming the first cross-linked foam. In the reforming process according to the present invention, an additional molding die for the re-forming may be prepared but a molding die that is used in the conventional re-forming process may also be used.

Many embodiments manufactured according to the present invention will be described more in detail with reference to the attached drawings hereinafter.

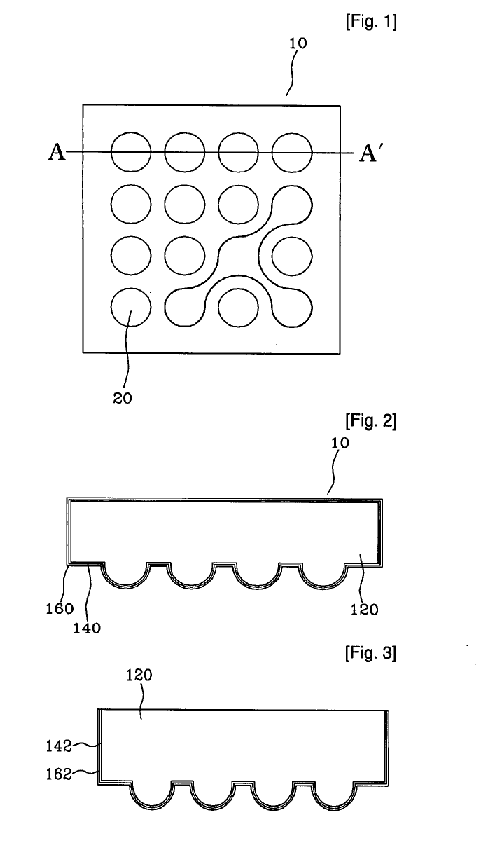

FIG. 1 is a plan view of a cross-linked foam having protrusions 20 according to an embodiment of the present invention and FIG. 2 is a cross-sectional view of the cross-linked foam taken along a line A-A′ of FIG. 1. A foam 10 is obtained by cross-linked foaming a foaming material for a foam body and two layers of foaming material for the outer skin covering the foaming material for the foam body entirely. That is, the foam 10 mainly consists of a foam body 120 and two layers of the outer skin 140 and 160 covering the whole surface of the foam body 120. The foam 10 having the foam body 120 and first and second outer skins 140 and 160 can be formed by a single process of cross-linked foaming without an additional attachment process between the foam body 120 and the outer skin 140 and between the first and second outer skins 140 and 160. The specific color of the foam can be realized by adding a certain pigment only to the second outer skin 160. A pigment for the same as or different color from the pigment included in the outer skins may also be included in the foam body 120. The same technique can be applied to other following embodiments though it is not described in detail in the following embodiments.

FIG. 3 is a cross-sectional view of a cross-linked foam according to another embodiment of the present invention. A foam of the present embodiment mainly comprises a foam body 120 and first and second outer skins 142 and 162 as in previous embodiment. However, the first and second outer skins 142 and 162 cover the foam body 120 partly leaving the rest of the portion open. Because a portion of the foam body 120 is exposed to the outside, the exposed portion of the foam body 120 can be seen from the outside and can be attached to another foam.

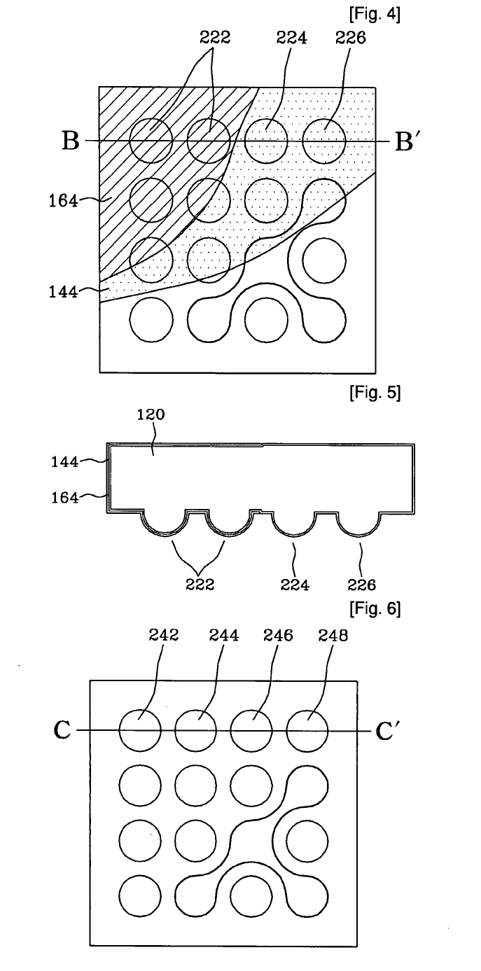

FIG. 4 is a plan view of a cross-linked foam according to another embodiment of the present invention and FIG. 5 is a cross-sectional view of the cross-linked foam taken along a line B-B′ of FIG. 4. A foam mainly comprises a foam body 120 and first and second outer skins 144 and 164 as in FIGS. 1 to 2. However, the first and second outer skins 144 and 164 do not cover the same portion of the foam body 120. Accordingly, the appearance observed from the outside varies according to the portions of the foam body. As shown in figures, the second outer skin 164 can be seen in a portion 222, the first outer skin 144 can be seen in a portion 224 and 226, and the foam body 120 can be seen in a portion under a second curve in FIG. 4. That is, the second outer skin 164 can be seen from the outside in a hatched area above a first curve in FIG. 4, the first outer skin 144 can be seen from the outside in a dotted area between the first and second curves in FIG. 4, and the foam body 120 can be seen in an area under a second curve in FIG. 4. Therefore, each portion of the foam can have a different color by including a different pigment to the foam body 120 and the outer skins 144 and 164.

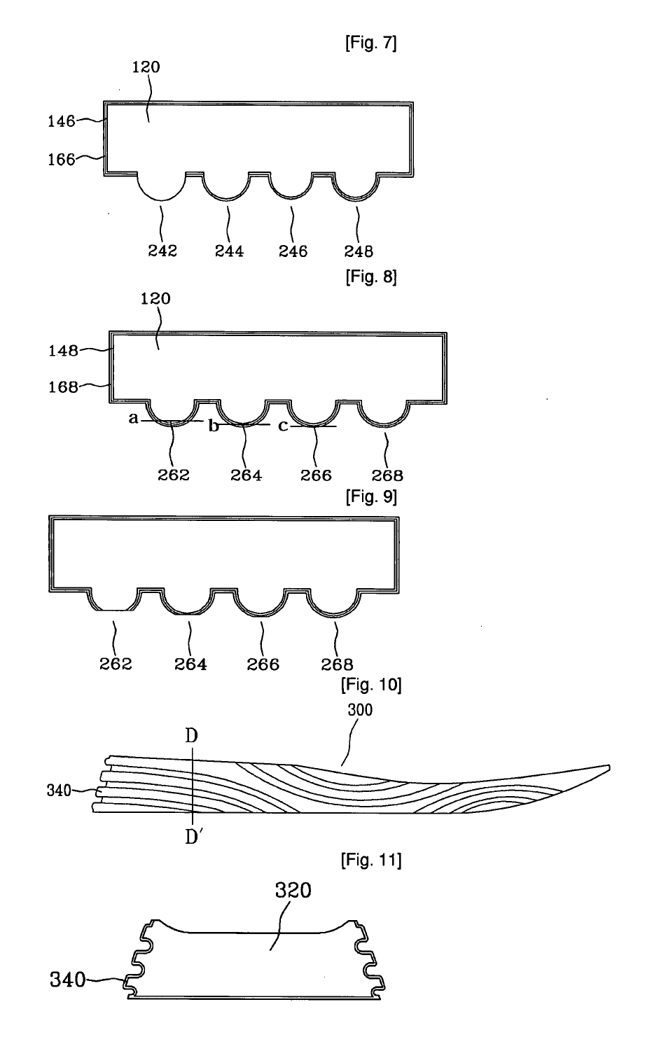

FIG. 6 is a plan view of a cross-linked foam according to another embodiment of the present invention and FIG. 7 is a cross-sectional view of the cross-linked foam taken along a line C-C′ of FIG. 6. A foam mainly comprises a foam body 120 and first and second outer skins 146 and 166 covering the foam body 120. In this embodiment, open portions such as a hole is formed in the foaming material for the outer skin before the cross-linked foaming process. In a portion 242, the hole is formed in foaming materials for the first and second outer skins at a corresponding position so that a portion of the foaming material for the foam body flows out of the hole during the cross-linked foaming process and can be seen from the outside. In a portion 244, the hole is formed only in the foaming material for the first outer skin so that a portion of the foaming material for the foam body flows out of the hole and is covered with the second outer skin 166. In a portion 246, the hole is formed only in the foaming material for the second outer skin 166 so that the portion of the foam body 120 is covered with the first outer skin 146 and cannot be seen from the outside. In a portion 248, the hole is not formed in the foaming material for the first and second outer skins so that the first and second outer skins 146 and 166 covers the foam body 120.

FIG. 8 is a cross-sectional view of a cross-linked foam of the present invention illustrating an additional process and FIG. 9 is a cross-sectional view of the cross-linked foam of the present invention after the additional process of FIG. 8. In this embodiment, a certain portion of the foam that is produced by any of methods described hereto is removed. If portions “a”, “b” and “c” of the foam having a foam body 120 and first and second outer skins 148 and 168 are removed, the final foam has a shape as shown in FIG. 9. In a portion “a”, the first and second outer skins 148 and 168 are removed so that a portion of the foam body 120 is exposed as in a portion 262 of FIG. 9. In a portion “b”, the second outer skin 168 or the second outer skin 168 and a portion of the first outer skin 148 is removed so that the first outer skin 148 is exposed to the outside as in a portion 264 of FIG. 9. If a portion of the second outer skin 168 is removed or the second outer skin 168 is not removed, the second outer skin 168 can be seen from the outside as in portions 266 and 268 of FIG. 9.

This embodiment differs from the previous embodiments in respect that the process of removing a portion of the foam is added and may be combined with other embodiments.

FIG. 10 is a side view of a shoe component according to an embodiment of the present invention and FIG. 11 is a cross-sectional view of the shoe component taken along a line D-D′ of FIG. 10. A foam 300 mainly has a foam body 320 having a complex unevenness on an outer surface and an outer skin 340 covering the foam body 320 along the unevenness of the foam body. As in this embodiment, any foam product having a complex shape can easily be formed using a thin film type foaming material according to the present invention. The color and appearance of the foam can be greatly improved by adding an expensive pigment such as a gloss pigment or a functional pigment such as a UV pigment only to the outer skin. At this case, the whole foam seems to include the high quality pigment.

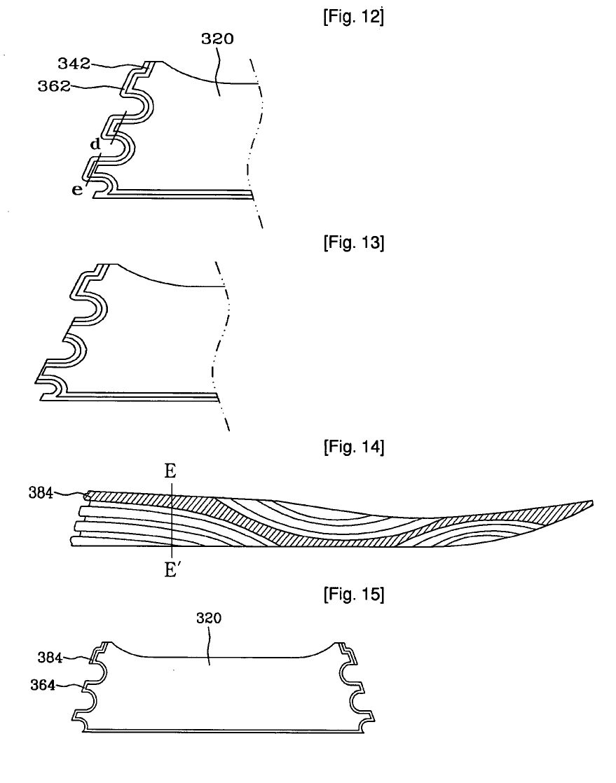

FIG. 12 is a partial cross-sectional view of a shoe component embodied according to another embodiment of the present invention and FIG. 13 is a partial cross-sectional view of the shoe component obtained by an additional process of FIG. 12. A foam mainly comprises a foam body 320 and first and second outer skins 342 and 362 that covers the foam body 320 having a complex unevenness on its side and bottom. In this embodiment, the portions illustrated as “d” and “e” in FIG. 12 are removed from the foam so that the foam having a changed shape as in FIG. 13 is obtained. That is, if the portion “d” is removed, a portion of the foam body 320 becomes exposed and if the portion “e” is removed, a portion of the first outer skin 342 becomes exposed. This removing process gives the foam a superior visual effect because a color and design of the foam is differentiated in each portion of the foam. The foam may be re-formed to make a surface treatment of the removed portion.

FIG. 14 is a side view of a shoe component according to another embodiment of the present invention and FIG. 15 is a cross-sectional view of the shoe component taken along a line E-E′ of FIG. 14. First and second outer skins 364 and 384 covers the foam body 320 as in the previous embodiment but the second outer skin 384 covers only a portion of the foam body 320 as shown in FIGS. 14 to 15. That is, the first outer skin 364 covers the side and bottom of the foam body 320 and the second outer skin 384 covers only a portion of the first outer skin 364 as shown in hatched area in FIG. 14. In this embodiment, the foam having a partially different color can be manufactured by a single cross-linked foaming process without an additional removing process.

It will be apparent to those skilled in the art that various modifications and variations can be made in the manufacturing method of a cross-linked foam without departing from the spirit or scope of the invention. Thus, it is intended that the present invention cover the modifications and variations of this invention provided they come within the scope of the appended claims and their equivalents.

1-23. (canceled)

24. A manufacturing method of a cross-linked foam, comprising:
processing foaming material for a foam body to have a certain shape with a cross-linked foaming suppressed and processing at least one foaming material for an outer skin to have a shape of a thin film with a cross-linked foaming suppressed, the foaming material for the outer skin including a pigment;
disposing the foaming material for the outer skin and the foaming material for the foam body in a molding die, the foaming material for the outer skin disposed in an inner cavity of the molding die and then the foaming material for the foam body disposed on the foaming material for the outer skin for the foaming material for the outer skin to cover a surface of the foaming material for the foam body; and
cross-linked foaming the disposed foaming material for the foam body and the outer skin, whereby
a united foam covered with the outer skin having a wide variety of colors can be manufactured even without an additional attachment or a painting process.

25. The method according to claim 24, wherein the foaming material for the foam body includes a pigment that is same as or different from the pigment included in the foaming material for the outer skin.

26. The method according to claim 24, wherein the foaming material for the outer skin covers the whole surface of the foaming material for the foam body when the foaming materials are disposed in the molding die.

27. The method according to claim 26, wherein the foaming material for the outer skin consists of plural foaming materials and at least one of the plural foaming materials covers the whole surface of the foaming material for the foam body.

28. The method according to claim 27, wherein each of the plural foaming materials for the outer skin includes either of same or different pigment.

29. The method according to claim 27, wherein only the outermost foaming material among the plural foaming materials for the outer skin includes the pigment.

30. The method according to claim 27, wherein the foaming material for the outer skin having a shape of a thin film is formed by processing a sheet or a pellet type foaming material with the cross-linked foaming suppressed.

31. The method according to claim 27, wherein the foaming material for the outer skin is a film having a uniform and even surface.

32. The method according to claim 24, wherein the foaming material for the outer skin covers a portion of the surface of the foaming material for the foam body when the foaming materials are disposed in the molding die.

33. The method according to claim 32, wherein the foaming material for the outer skin consists of plural foaming materials and at least one of the plural foaming materials covers a portion of the surface of the foaming material for the foam body.

34. The method according to claim 33, wherein each of the plural foaming materials for the outer skin includes either of same or different pigment.

35. The method according to claim 33, wherein only the outermost foaming material among the plural foaming materials for the outer skin includes the pigment.

36. The method according to claim 33, wherein the foaming material for the outer skin having a shape of a thin film is formed by processing a sheet or a pellet type foaming material with the cross-linked foaming suppressed.

37. The method according to claim 33, wherein the foaming material for the outer skin is a film having a uniform and even surface.

38. The method according to claim 24, wherein the foaming material for the outer skin further has at least one open portion.

39. The method according to claim 24, further comprising removing a portion of the outer skin to expose a portion of the foam body or a portion of another outer skin after the cross-linked foaming process.

40. The method according to claim 39, further comprising re-molding the foam after the removing process for a surface treatment of the exposed portion.

41. The method according to claim 24, wherein foaming material having a shape of a sheet or a pellet with the cross-linked foaming suppressed is used for the foaming material for the foam body.

42. The method according to claim 24, wherein the foaming material for the foam body is formed by processing foaming material having a shape of a sheet or a pellet with the cross-linked foaming suppressed.

43. The method according to claim 24, wherein the foaming material for the foam body is formed by laminating plural foaming materials having a shape of a thin film with the cross-linked foaming suppressed.

44. The method according to claim 43, wherein each of the plural foaming materials for the foam body is a film having a uniform and even surface.

45. The method according to claim 43, wherein each of the plural foaming materials having a shape of a thin film is formed by processing a sheet or a pellet type foaming material with the cross-linked foaming suppressed.

46. The method according to claim 24, wherein the foaming material for the outer skin having a shape of a thin film is formed by processing a sheet or a pellet type foaming material with the cross-linked foaming suppressed.

47. The method according to claim 24, wherein the foaming material for the outer skin is a film having a uniform and even surface.

48. A manufacturing method of a cross-linked foam, comprising:
firstly processing foaming material for a foam body to have a certain shape with a cross-linked foaming suppressed and processing at least one foaming material for an outer skin to have a shape of a thin film with a cross-linked foaming suppressed, the foaming material for the outer skin including a pigment;
secondly processing the firstly processed foaming materials to obtain an united foaming material by covering a surface of the foaming material for the foam body with the foaming material for the outer skin;
disposing the united foaming material in a molding die; and
cross-linked foaming the disposed foaming material, whereby
a united foam covered with the outer skin having a wide variety of colors can be manufactured even without an additional attachment or a painting process.

49. The method according to claim 48, wherein the foaming material for the foam body includes a pigment that is same as or different from the pigment included in the foaming material for the outer skin.

50. The method according to claim 48, wherein the whole surface of the firstly processed foaming material for the foam body is tightly covered with the firstly processed foaming material for the outer skin during the second process of the foaming materials.

51. The method according to claim 50, wherein the foaming material for the outer skin consists of plural foaming materials and at least one of the plural foaming materials covers the whole surface of the foaming material for the foam body.

52. The method according to claim 51, wherein each of the plural foaming materials for the outer skin includes either of same or different pigment.

53. The method according to claim 51, wherein only the outermost foaming material among the plural foaming materials for the outer skin includes the pigment.

54. The method according to claim 51, wherein the foaming material for the outer skin having a shape of a thin film is formed by processing a sheet or a pellet type foaming material with the cross-linked foaming suppressed.

55. The method according to claim 51, wherein the foaming material for the outer skin is a film having a uniform and even surface.

56. The method according to claim 48, wherein a portion of the surface of the firstly processed foaming material for the foam body is tightly covered with the firstly processed foaming material for the outer skin during the second process of the foaming materials.

57. The method according to claim 56, wherein the foaming material for the outer skin consists of plural foaming materials and at least one of the plural foaming materials covers a same portion of the surface of the foaming material for the foam body.

58. The method according to claim 57, wherein each of the plural foaming materials for the outer skin includes either of same or different pigment.

59. The method according to claim 57, wherein only the outermost foaming material among the plural foaming materials for the outer skin includes the pigment.

60. The method according to claim 57, wherein the foaming material for the outer skin having a shape of a thin film is formed by processing a sheet or a pellet type foaming material with the cross-linked foaming suppressed.

61. The method according to claim 57, wherein the foaming material for the outer skin is a film having a uniform and even surface.

62. The method according to claim 48, wherein the foaming material for the outer skin further has at least one open portion.

63. The method according to claim 48, further comprising removing a portion of the outer skin to expose a portion of the foam body or a portion of another outer skin after the cross-linked foaming process.

64. The method according to claim 63, further comprising re-molding the foam after the removing process for a surface treatment of the exposed portion.

65. The method according to claim 48, wherein foaming material having a shape of a sheet or a pellet with the cross-linked foaming suppressed is used for the foaming material for the foam body.

66. The method according to claim 48, wherein the foaming material for the foam body is formed by processing foaming material having a shape of a sheet or a pellet with the cross-linked foaming suppressed.

67. The method according to claim 48, wherein the foaming material for the foam body is formed by laminating plural foaming materials having a shape of a thin film with the cross-linked foaming suppressed.

68. The method according to claim 67, wherein each of the plural foaming materials for the foam body is a film having a uniform and even surface.

69. The method according to claim 67, wherein each of the plural foaming materials having a shape of a thin film is formed by processing a sheet or a pellet type foaming material with the cross-linked foaming suppressed.

70. The method according to claim 48, wherein the foaming material for the outer skin having a shape of a thin film is formed by processing a sheet or a pellet type foaming material with the cross-linked foaming suppressed.

71. The method according to claim 48, wherein the foaming material for the outer skin is a film having a uniform and even surface.
